(19) United States
(12) Patent Application Publication
(10) Pub. No.: US 2017/0123119 A1
(43) Pub. Date: May 4, 2017

(54) DISPLAY DEVICE

(71) Applicant: BOE TECHNOLOGY GROUP CO., LTD., Beijing (CN)

(72) Inventors: Yong Hu, Beijing (CN); Xinyin Wu, Beijing (CN); Yong Qiao, Beijing (CN); Jianbo Xian, Beijing (CN)

(21) Appl. No.: 15/104,936

(22) PCT Filed: Sep. 22, 2015
(86) PCT No.: PCT/CN2015/090239

§ 371 Date: Jun. 15, 2016

(30) Foreign Application Priority Data
May 26, 2015 (CN) 201520348685.9

(51) Int. Cl. G02B 5/20; G02B 5/22

(52) U.S. Cl. CPC G02B 5/201; G02B 5/22

(57) ABSTRACT

A display device includes a first substrate and a second substrate, which are disposed opposite to each other, and a display medium layer, which is hermetically disposed between the first substrate and the second substrate. The first substrate is provided with a color filter layer in a first region thereof, and the first or second substrate is provided with a spacer in a second region thereof. In a display area, a projection of the second region where the spacer is disposed in a direction perpendicular to the first substrate is not overlapped with a projection of the first region where the color filter layer is disposed in the direction perpendicular to the first substrate. In the display device, a position of the spacer is not affected by the color filter layer, so that there are more choices for the position of the spacer and the spacer may be more stable.

### CROSS-REFERENCE TO RELATED APPLICATION

This application is a Section 371 National Stage Application of International Application No. PCT/CN2015/090239, filed on Sep. 22, 2015, entitled “DISPLAY DEVICE”, which has not yet published, which claims priority to Chinese Application No. 201520348685.9 filed on May 26, 2015, incorporated herein by reference in their entirety.

### BACKGROUND OF THE INVENTION

Field of the Invention

Embodiments of the present disclosure relate to a field of display technology, in particular, to a display device.

Description of the Related Art

A photoelectric display generally consists of two oppositely disposed substrates and photoelectric display medium enclosed between the two substrates. In order to make the display have a uniform thickness and a good recovery ability under external force, a spacer is typically provided between the two substrates. For better stability, a region where the spacer is arranged is required to have good flatness and simple structure.

FIG. 1 is a schematic plan view of an existing display device and FIG. 2 is a cross-section view of the existing display device. As shown in FIGS. 1 and 2, regions where black matrixes 3 are located are non-light-transmitting regions and regions 4 are light transmitting regions. Spacers 1 are disposed in the non-light-transmitting regions. Color filter layers 2 not only overlap fully with the light transmitting regions but also overlap partially with the non-light-transmitting regions, moreover, the color filter layers 2 may overlap with the regions where the spacers 1 are located. This configuration may cause the following defect.

As shown in FIG. 2, two adjacent color filter layers 2 may overlay with one another so that an uneven region may be produced, so that the spacer may be unstable if the spacer is disposed in a region where the two adjacent color filter layers 2 overlay. Thereby, selections on positions of the spacers are limited.

### SUMMARY OF THE INVENTION

The present disclosure aims to provide a display device, in which a position of a spacer is not affected by a color filter layer so that there are more choices for the position of the spacer and the spacer may be more stable.

In order to obtain the above objective, an embodiment of the present disclosure provides a display device comprising a first substrate and a second substrate, which are disposed opposite to one another, and a display medium layer, which is hermetically disposed between the first substrate and the second substrate, the first substrate being provided with a color filter layer in a first region thereof, the first or second substrate being provided with a spacer in a second region thereof, wherein a projection of the second region where the spacer is disposed in a direction perpendicular to the first substrate is not overlapped with a projection of the first region where the color filter layer is disposed in the direction perpendicular to the first substrate.

Preferably, the color filter layer has a non-continuous region, and the projection of the second region in the direction perpendicular to the first substrate is located within the non-continuous region.

Preferably, the color filter layer consists of a plurality of filter sub-layers which are independent of one another, and a gap is formed between adjacent filter sub-layers to form the non-continuous region.

Preferably, the color filter layer has a through hole to form the non-continuous region.

Preferably, an area of the non-continuous region is larger than an area of the second region where the spacer is disposed.

Preferably, the non-continuous region has a shape chosen from oval, circle, triangle, polygon or grid consisting of polygons.

Preferably, the projection of the second region where the spacer is disposed in the direction perpendicular to the first substrate has a shape chosen from circle, oval, or polygon.

Preferably, the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is fully or partially overlapped with the plurality of light transmitting regions and is partially overlapped with the non-light-transmitting regions; and wherein the second region where the spacer is disposed is located within the non-light-transmitting regions.

Preferably, the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is only fully overlapped with the plurality of light transmitting regions; and wherein the second region where the spacer is disposed is located within the non-light-transmitting regions.

Preferably, an area of the projection of the first region in the direction perpendicular to the substrate is larger than an area of the projection of the light transmitting regions in the direction perpendicular to the substrate.

Preferably, the first substrate is a color film substrate or the first substrate is an array substrate.

In the display device according to the above embodiments of the present disclosure, a projection of the first region where the color filter layer is disposed in a direction perpendicular to the first substrate is not overlapped with a projection of the second region where the spacer is disposed in the direction perpendicular to the first substrate, in a display area, so that a position of the spacer is not affected by the color filter layer, that is, there are more choices for the position of the spacer. Also, as there is no color filter layer at a position corresponding to the spacer, the number of layers between the spacer and the substrate may be decreased, so that the spacer may be more stable.

### BRIEF DESCRIPTION OF THE DRAWINGS

The following drawings are provided to assist in understanding further the present disclosure and consist of a part of the specification. Also, the drawings together with the following specific embodiments are used to explain the present disclosure, however, they are not constructed as limiting the present disclosure.

FIG. 1 is a schematic plan view of an existing display device;

FIG. 2 is a cross-section view of the existing display device;

FIG. 3 is a cross-section view of a display device according to an embodiment of the present disclosure;

FIG. 4 is a schematic plan view of the display device according to the embodiment of the present disclosure; and

FIG. 5 is a schematic plan view of a display device according to another embodiment of the present disclosure.

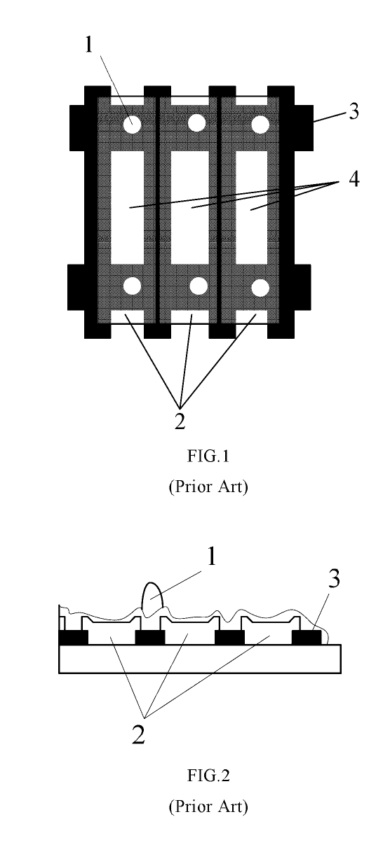

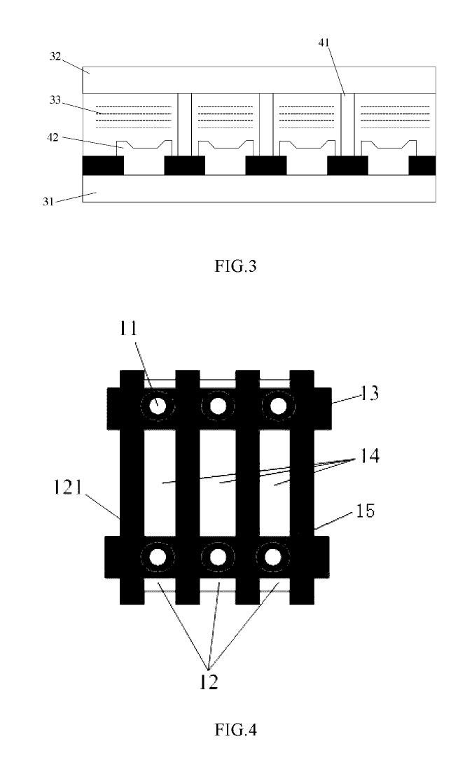

### DETAILED DESCRIPTION OF PREFERRED EMBODIMENTS OF THE INVENTION

With reference to the following specific embodiments of the present invention will be described in detail. It should be understood that the specific embodiments described herein are only intended to illustrate and explain the present invention and are not intended to limit the present invention.

The present disclosure provides a display device including a first substrate and a second substrate, which are disposed opposite to one another, and a display medium layer, which is hermetically disposed between the first substrate and the second substrate. The first substrate is provided with a color filter layer in a first region thereof, and the first or second substrate is provided with a spacer in a second region thereof. In a display area, a projection of the second region where the spacer is disposed in a direction perpendicular to the first substrate is not overlapped with a projection of the first region where the color filter layer is disposed in the direction perpendicular to the first substrate, so that a position of the spacer is not affected by the color filter layer, that is, there are more choices for the position of the spacer. Also, as there is no color filter layer at a position corresponding to the spacer, the number of layers between the spacer and the substrate may be decreased, so that the spacer may be more stable.

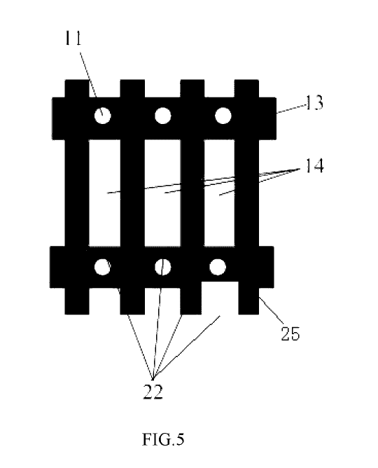

Next, a specific implementation of a display device according to an embodiment of the present disclosure will be described in detail. Specifically, FIG. 3 is a cross-section view of a display device according to an embodiment of the present disclosure, FIG. 4 is a schematic plan view of the display device according to the embodiment of the present disclosure. Referring to FIGS. 3 and 4, the display device comprises a first substrate 31 and a second substrate 32 which are disposed opposite to one another. A display medium layer 33 is hermetically disposed between the first substrate 31 and the second substrate 32. A color filter layer 42 is disposed in a first region 12 of the first substrate 31, and a spacer 41 is disposed in a second region 11 of the first or second substrate. A through hole 15 is disposed in the color filter layer 42, and the second region 11 where the spacer is disposed is located within a third region 121 where the through hole is disposed, so that the second region 11 where the spacer is disposed is not overlapped with the first region 12 where the color filter layer is disposed. In other words, the color filter layer may be provided with discontinuous regions, in this embodiment, the third region 121 where the through hole 15 is disposed is just the discontinuous region. A projection of the second region 11, where the spacer is disposed, in a direction perpendicular to the first substrate is located within the discontinuous region, so that the second region 11 where the spacer is disposed is not overlapped with the first region 12 where the color filter layer is disposed.

During preparing the color filter layer, a part of the color filter layer corresponding to a bottom of the spacer and a region surrounding the bottom may be removed so as to form the through hole in the color filter layer, thereby the second region 11 corresponding to the spacer can be located within the third region 121 where the through hole is disposed. In an actual application, a shape of the third region 121 corresponding to the through hole may be designed as required, for example, it may be one chosen from oval, circle, triangle, polygon, grid consisting of polygons, etc.

In this embodiment, the substrate on which the color filter layer is located comprises a plurality of light transmitting regions 14 and non-light-transmitting regions 13 excluding the plurality of light transmitting regions 14. The non-light-transmitting regions 13 are typically regions covered by black matrixes and the light transmitting regions 14 are regions which are not covered by the black matrixes. Also, the light transmitting regions 14 are separated from one another, as shown in FIG. 4. In this substrate, the first region 12 where the color filter layer is disposed may be fully overlapped with the plurality of light transmitting regions 14 and partially overlapped with the non-light-transmitting regions 13. Further, the second region 11 where the spacer is disposed may be located in the non-light-transmitting regions 13.

Of course, in an actual application, the first region where the color filter layer is disposed may be partially overlapped with the plurality of light transmitting regions and partially overlapped with the non-light-transmitting regions 13 according to specific requirement.

It should be noted that, though the second region 11 where the spacer is disposed has a circular shape in this embodiment, the present disclosure is limited thereto. In an actual application, the second region where the spacer is disposed may have any other shape, such as oval, polygon, etc.

FIG. 5 is a schematic plan view of a display device according to another embodiment of the present disclosure. The display device as shown in FIG. 5 differs from the display device according to the above embodiment in that there is no through hole in the color filter layer in FIG. 5 and the color filter layer consists of a plurality of filter sub-layers 22 which are independent of one another, further, a gap (as indicated by a gap 25 as shown in FIG. 5) is formed between adjacent filter sub-layers, so that the gap 25 corresponds to the non-continuous region. Also, the second region where the color filter layer is disposed is only partially overlapped with the plurality of light transmitting regions.

Specifically, as shown in FIG. 5, the substrate on which the color filter layer is located comprises a plurality of light transmitting regions 14 and non-light-transmitting regions 13 excluding the light transmitting regions 14. The plurality of light transmitting regions 14 are separated from one another. With regard to this substrate, the first region 22 where the color filter layer is disposed may be only fully overlapped with the plurality of light transmitting regions 14 and not overlapped with the non-light-transmitting region 13. Also, the second region 11 where the spacer is disposed is located within the non-light-transmitting region 13, so that the second region 11 where the spacer is disposed is not overlapped with the first region 22 where the color filter layer is disposed. In other words, the second region 11 where the spacer is disposed and the first region 22 where the color filter layer is disposed in different regions, respectively.

Alternatively, an area of the first region 22 where the color filter layer is disposed is larger than an area of the light transmitting region 14 so that the first region 22 where the color filter layer is disposed is capable of extending outwards from an edge of the light transmitting region 14 by a distance, in other words, the first region 22 where the color filter layer is disposed is overlapped with a small part of the non-light-transmitting region 13 surrounding the light transmitting region 14, so as to avoid that the light transmitting region 14 is not completely covered by the first region 22 where the color filter layer is disposed due to manufacture error.

During preparing the color filter layer, only the color filter layer corresponding to the light transmitting region 14 and covering edges of the light transmitting region 14 may be kept, so that the color filter layer may form a non-continuous region which only covers the light transmitting regions and the edges thereof, that is, a plurality of filter sub-layers which are independent of one another.

In summary, in the display device according to the above embodiments of the present disclosure, a projection of the first region where the color filter layer is disposed in a direction perpendicular to the first substrate is not overlapped with a projection of the second region where the spacer is disposed in the direction perpendicular to the first substrate, in a display area, so that a position of the spacer is not affected by the color filter layer, that is, there are more choices for the position of the spacer. Also, as there is no color filter layer at a position corresponding to the spacer, the number of layers between the spacer and the substrate may be decreased, so that the spacer may be more stable.

It will be appreciated that the above embodiments are merely exemplary embodiments to illustrate the principle of the present disclosure, however, the present invention is not limited thereto. Those skilled in the art may make various modifications and improvements without departing from the spirit and substance of the present invention, and such variations and modifications are also considered as the scope of the present invention.

1. A display device comprising a first substrate and a second substrate, which are disposed opposite to one another, and a display medium layer, which is hermetically disposed between the first substrate and the second substrate, the first substrate being provided with a color filter layer in a first region thereof, the first or second substrate being provided with a spacer in a second region thereof, wherein a projection of the second region where the spacer is disposed in a direction perpendicular to the first substrate is not overlapped with a projection of the first region where the color filter layer is disposed in the direction perpendicular to the first substrate.

2. The display device according to claim 1, wherein the color filter layer has a non-continuous region, and the projection of the second region in the direction perpendicular to the first substrate is located within the non-continuous region.

3. The display device according to claim 2, wherein the color filter layer consists of a plurality of filter sub-layers which are independent of one another, and a gap is formed between adjacent filter sub-layers to form the non-continuous region.

4. The display device according to claim 2, wherein the color filter layer has a through hole to form the non-continuous region.

5. The display device according to claim 2, wherein an area of the non-continuous region is larger than an area of the second region where the spacer is disposed.

6. The display device according to claim 2, wherein the non-continuous region has a shape chosen from oval, circle, triangle, polygon or grid consisting of polygons.

7. The display device according to claim 1, wherein the projection of the second region where the spacer is disposed in the direction perpendicular to the first substrate has a shape chosen from circle, oval, or polygon.

8. The display device according to claim 1, wherein the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is fully or partially overlapped with the plurality of light transmitting regions and is partially overlapped with the non-light-transmitting regions; and
wherein the second region where the spacer is disposed is located within the non-light-transmitting regions.

9. The display device according to claim 3, wherein the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is only fully overlapped with the plurality of light transmitting regions; and
wherein the second region where the spacer is disposed is located within the non-light-transmitting regions.

10. The display device according to claim 8, wherein an area of the projection of the first region in the direction perpendicular to the substrate is larger than an area of the projection of the light transmitting regions in the direction perpendicular to the substrate.

11. The display device according to claim 1, wherein the first substrate is a color film substrate, or the first substrate is an array substrate.

12. The display device according to claim 3, wherein an area of the non-continuous region is larger than an area of the second region where the spacer is disposed.

13. The display device according to claim 4, wherein an area of the non-continuous region is larger than an area of the second region where the spacer is disposed.

14. The display device according to claim 3, wherein the non-continuous region has a shape chosen from oval, circle, triangle, polygon or grid consisting of polygons.

15. The display device according to claim 4, wherein the non-continuous region has a shape chosen from oval, circle, triangle, polygon or grid consisting of polygons.

16. The display device according to claim 2, wherein the projection of the second region where the spacer is disposed in the direction perpendicular to the first substrate has a shape chosen from circle, oval, or polygon.

17. The display device according to claim 6, wherein the projection of the second region where the spacer is disposed in the direction perpendicular to the first substrate has a shape chosen from circle, oval, or polygon.

18. The display device according to claim 2, wherein the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is fully or partially overlapped with the plurality of light transmitting regions and is partially overlapped with the non-light-transmitting regions; and
wherein the second region where the spacer is disposed is located within the non-light-transmitting regions.

19. The display device according to claim 3, wherein the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is fully or partially overlapped with the plurality of light transmitting regions and is partially overlapped with the non-light-transmitting regions; and
wherein the second region where the spacer is disposed is located within the non-light-transmitting regions.

20. The display device according to claim 4, wherein the substrate where the color filter layer is located comprises a plurality of light transmitting regions and non-light-transmitting regions excluding the plurality of light transmitting regions, and wherein the plurality of light transmitting regions are separated from one another, and the first region where the color filter layer is disposed is fully or partially overlapped with the plurality of light transmitting regions and is partially overlapped with the non-light-transmitting regions; and
wherein the second region where the spacer is disposed is located within the non-light-transmitting regions.
